(19) United States
(12) Patent Application Publication
(10) Pub. No.: US 2023/0114409 A1
(43) Pub. Date: Apr. 13, 2023

(54) SYSTEM AND METHOD FOR AN OBJECT STORE PRE-CHECK

(71) Applicant: Nutanix, Inc., San Jose, CA (US)

(72) Inventors: Anoop Reddy, San Jose, CA (US); Asavari Limaye, Sunnyvale, CA (US); Xuerong Hu, Union City, CA (US); Xingchi Jin, Union City, CA (US)

(73) Assignee: Nutanix, Inc., San Jose, CA (US)

(21) Appl. No.: 17/963,434

(22) Filed: Oct. 11, 2022

Related U.S. Application Data
(60) Provisional application No. 63/254,667, filed on Oct. 12, 2021.

(51) Int. Cl. G06F 9/455

(52) U.S. Cl. CPC G06F 9/45558; G06F 2009/45595; G06F 2009/4557

(57) ABSTRACT

In some aspects, a non-transitory computer readable medium includes instructions when executed by a processor cause the processor to configure an object store, execute a pre-check of the configuration of the object store, provide an indication that the pre-check has passed, and responsive to providing the indication that the pre-check has passed, permit a selection to deploy the object store.

This application claims priority to US Provisional Application No. 63/254,667 filed Oct. 12, 2021, which application is hereby incorporated by reference for all it discloses.

### BACKGROUND

Virtual computing systems are widely used in a variety of applications. Virtual computing systems include one or more host machines running one or more virtual machines and other entities (e.g., containers) concurrently. Modern virtual computing systems allow several operating systems and several software applications to be safely run at the same time, thereby increasing resource utilization and performance efficiency. However, the present-day virtual computing systems have limitations due to their configuration and the way they operate.

### SUMMARY

The disclosure relates generally to object storage and, more particularly, to systems and methods for an object store deployment pre-check.

In some aspects, a non-transitory computer readable medium includes instructions when executed by a processor cause the processor to configure an object store, execute a pre-check of the configuration of the object store, provide an indication that the pre-check has passed, and responsive to providing the indication that the pre-check has passed, permit a selection to deploy the object store.

In some aspects, an apparatus includes a processor and memory. In some embodiments, the memory includes instructions that, when executed by the processor, cause the apparatus to configure an object store, execute a pre-check of the configuration of the object store, provide an indication that the pre-check has passed, and responsive to providing the indication that the pre-check has passed, permit a selection to deploy the object store.

In some aspects, a computer-implemented method includes configuring an object store, executing a pre-check of the configuration of the object store, providing an indication that the pre-check has passed, and responsive to providing the indication that the pre-check has passed, permitting a selection to deploy the object store.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is an example block diagram of a computer system, in accordance with some embodiments of the present disclosure.

FIG. 2 is an example block diagram of a pre-check service, in accordance with some embodiments of the present disclosure.

FIGS. 3A-3G are example displays of a user interface, in accordance with some embodiments of the present disclosure.

FIG. 4 is a flowchart of an example method of performing a pre-check, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

In some embodiments, an object store deployment consumes significant time (e.g., greater than 30 minutes) only to fail in the middle of, or at the end of, the deployment. In some embodiments, an object store configuration or network port reachability can only be checked mid-deployment. What is needed is a tool to validate an object store environment.

Disclosed herein are embodiments of a system and method for executing a pre-check of an object store deployment. The system and method can collect input for deployment. The system and method can run pre-checks on a central manager. In response to a check failing, system and method can modify firewall settings, fix errors, and repeat the pre-check. The system and method can deploy the object store using a user interface or a command line interface.

Advantageously, in one aspect, the system and method improve the user experience while deploying the object store. In some embodiments, the system and method reduce deployment wait time and simplify troubleshooting by catching misconfigurations before the object store deployment is initialized.

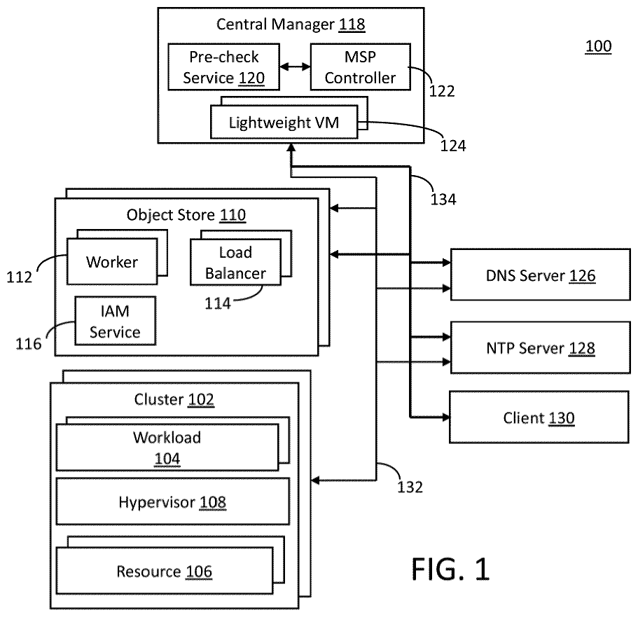

FIG. 1 is an example block diagram of a computer system 100, in accordance with some embodiments of the present disclosure. The computer system 100 includes one or more clusters such as cluster 102. The cluster 102 may refer to a cluster of (e.g., a number of) hosts (e.g., host machines, machines, nodes, etc.) or a cluster of workloads. The cluster 102 includes one or more workloads such as the workload 104. The workload 104 can be one of a virtual machine (VM), a container, a microservice, etc. The cluster 102 includes a number of resources such as resource 106. The resources can be distributed across the number of hosts of the cluster 102. The resource 106 can be a storage (e.g., storage and/or memory) resource, a compute (e.g., central processing unit (CPU) and/or memory) resource, or a network resource.

The cluster 102 includes a hypervisor 108. The hypervisor 108 can be a type-1 hypervisor, a type-2 hypervisor, a hypervisor from any of various vendors, etc. The workload 104 runs one or more services/applications/operating systems by using the resource 106, which is virtualized through the hypervisor 108 as a virtual resource (e.g., virtual disk, virtual CPU, virtual memory, etc.). In some embodiments, the cluster 102 is a hyper-converged infrastructure (HCl) cluster. In some embodiments, each host as a hypervisor such as the hypervisor 108. An HCl cluster is a cluster in which a number of disparate resources (e.g., storage, compute, and network resources) are deployed, allocated, or otherwise managed, by a single component. The 102 cluster can be located in one data center (e.g., on-premises), in a cloud, across multiple data centers, multiple clouds or across a combination of one or more data centers and one or more clouds (e.g., hybrid cloud).

The computer system 100 includes one or more object stores such as the object store 110. A workload in a virtualized environment can be configured to run software-defined object storage service. Unlike file or block storage, the object storage architecture model handles data as objects in an unstructured manner. Unstructured data is data organized in a flat hierarchy, such as a bucket, with no directory structures, recursion, sub-folders, or traditional blocks. The buckets can be backed by resources such as the resource 106 through the hypervisor 108. The buckets can be accessed with an endpoint such a uniform resource locator (URL).

In some embodiments, each object in the object store 110 comprises the data, its metadata, and a unique key used to identify the object. The metadata used in object storage may contain granular information about the objects it describes, giving flexibility and greater control when managing and manipulating an object at any point in its life cycle. Other storage solutions such as file systems and relational databases typically have higher-level metadata, which situates the additional handling of contextual information about the data in the high-level applications that use that data. In some embodiments, an object is immutable data. In some embodiments, an object is unstructured data. An object can be a file, a document, a spreadsheet, a video, data, metadata, etc.

The object store 110 may perform various operations on objects and buckets such as deploying (e.g., creating) buckets, adding objects to the buckets, looking up the objects, versioning the objects, tagging the objects, maintaining the lifecycle of the objects, controlling access of the objects, deleting the objects, deleting the buckets, and the like, using one or more application programming interfaces (APIs). This type of storage architecture may provide greater accessibility and velocity when handling the data because it removes the complexities and overhead introduced by multiple layers of formatting.

In some embodiments, the object store 110 includes a number of workers such as the worker 112. The worker 112 services API requests by executing tasks associated with the API requests. The object store includes a number of load balancers such as the load balancer 114. The load balancer 114 allocate tasks to (e.g., schedules tasks for) workers based on resource capacity of each of the workers. In some embodiments, each of the worker 112 and the load balancer 114 is a VM, a container, or a (e.g., containerized) microservice. In some embodiments, the object store 110 includes an identity and access management (IAM) service 116. The IAM service 116 manages security (e.g., authentication, authorization) of the object store 110. In some embodiments, the IAM service 116 uses attribute-based access control (ABAC).

The computer system 100 includes a central manager 118. The central manager 118 manages a number of clusters (e.g., and a number of VMs thereon) across separate physical locations. The central manager 118 can be deployed in a VM or in a distributed cluster of VMs, in which each VM runs a central manager instance of the central manager 118.

The central manager 118 includes a pre-check service 120. The pre-check service 120 checks (e.g., validates, tests, etc.) a configuration of an object store before the object store is deployed. In some embodiments, the central manager 118 includes a microservices platform (MSP) controller 122. The MSP controller 122 can manage microservices running in, or associated with the object store 110.

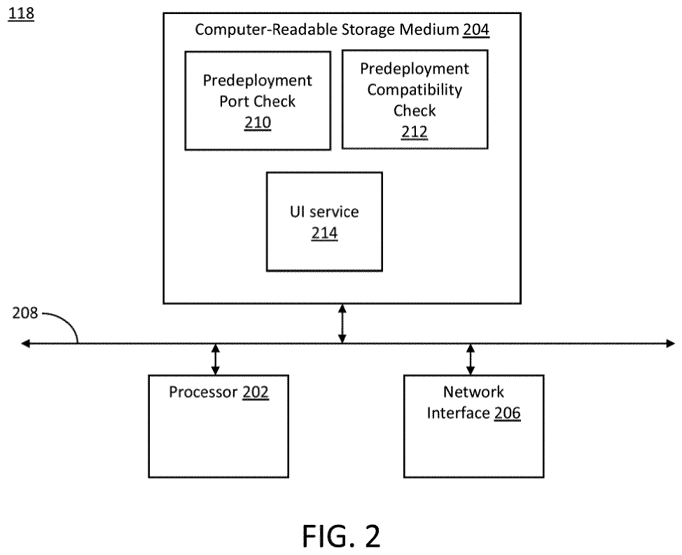

In some embodiments, the central manager 118 includes a number of lightweight VMs such as the lightweight VM 124. The lightweight VM 124 may be referred to as a dummy VM. In some embodiments, the lightweight VM 124 is deployed by the pre-check service 120 in order to perform pre-check functions which are described with respect to FIG. 2. In some embodiments, the lightweight VM 124 is a VM with a small image from which the VM boots or loads. For example, the image has a size less than 1 GB, 100 MB, or 10 MB. In some embodiments, the image is stored in a cache. In some embodiments, the cache is a content-based read cache (CBRC). In some embodiments, the cache stores the image and metadata about the image such as a block, offset, or other location information of the image. In some embodiments, the lightweight VM 124 uses proprietary APIs or remote procedure calls (RPCs).

The central manager 118 includes a domain name system (DNS) server 126, a network time protocol (NTP) server 128, and a client 130. The DNS server can translate human readable domain names to machine readable internet protocol (IP) addresses. The NTP server can synchronize computer clock times in the computer system 100. The client 130 may be an endpoint for a cloud-based object storage service.

The computer system 100 includes an internal network 132. The internal network 132 may be referred to as a storage network. In some embodiments, the cluster 102, the object store 110, the central manager 118, the DNS server 126, and the NTP server 128 are coupled through the internal network 132, although more or less components may be coupled through the internal network 132 while remaining in the scope of the present disclosure. The computer system 100 includes an external network 134. The external network 134 may be referred to as a client access network. In some embodiments, the object store 110, the central manager 118, the DNS server 126, the NTP server 128, and the client 130 are coupled through the external network 134, although more or less components may be coupled through the external network 134 while remaining in the scope of the present disclosure.

In some embodiments, the central manager 118 deploys the lightweight VM 124 on one of the components coupled to the internal network 132 or the external network 134. The lightweight VM 124 can send a request to another component in the internal network 132 and wait for an expected response. In some embodiments, if the expected response is received within a first time interval, the lightweight VM 124 determines that there is connectivity between the component and the another component. In some embodiments, the central manager 118 deploys the lightweight VM 124 on multiple components. In some embodiments, the central manager 118 deploys the lightweight VM 124 on at least one component coupled to the internal network 132 and at least one component coupled to the external network 134. In some embodiments, the lightweight VM 124 is deployed using a plugin (e.g., a selectable plugin).

Referring now to FIG. 2, a block diagram of the pre-check service 120 is illustrated, in accordance with some embodiments of the present disclosure. The pre-check service 120 includes a processor 202. Processor 202 is configured to execute computer program code, scripts, applications, services, or plugins, such as a predeployment port check 210, a predeployment compatibility check 212, and a user interface (UI) service 214, encoded in computer-readable storage medium 204 (referred to herein as storage medium 204). In one or more embodiments, processor 202 is a central processing unit (CPU), a multi-processor, a distributed processing system, an application specific integrated circuit (ASIC), and/or a suitable processing unit. In some embodiments, the processor 202 is a virtual representation of one of the compute resources (e.g. the resource 106) of FIG. 1.

The pre-check service 120 includes the storage medium 204. In one or more embodiments, the storage medium 204 is an electronic, magnetic, optical, electromagnetic, infrared, and/or a semiconductor system (or apparatus or device). For example, the storage medium 204 includes a semiconductor or solid-state memory, a random access memory (RAM), a read-only memory (ROM), a magnetic tape, a removable computer diskette, a rigid magnetic disk, and/or an optical disk. In some embodiments, the storage medium 204 is a virtual representation of one of the storage resources (e.g. the resource 106) of FIG. 1.

The storage medium 204 includes the predeployment port check 210. The predeployment port check 210 determines (e.g., checks, tests) whether there is connectivity between a pair of ports. The first port can be for a first application and the second port can be for a second application. In some embodiments, the predeployment port check 210 determines connectivity between a pair of ports on the internal network 132. For example, the predeployment port check 210 determines internal network connectivity between the central manager 118 and the cluster 102, between the central manager 118 and the object store 110, between the central manager 118 and the DNS server 126, and between the central manager 118 and the NTP server 128.

In some embodiments, the predeployment port check 210 determines connectivity between a pair of ports on the external network 134. For example, the predeployment port check 210 determines external network connectivity between the central manager 118 and the object store 110, between the central manager 118 and the DNS server 126, between the central manager 118 and the NTP server 128, and between the central manager 118 and the client 130.

The storage medium 204 includes the predeployment compatibility check 212. The predeployment compatibility check 212 determines whether different components in the computer system 100 are compatible with each other. For example, the predeployment compatibility check 212 determines whether a version of the object store 110 is compatible with a version of the central manager 118, whether a version of the object store 110 is compatible with a version of the cluster 102, and whether a version of the cluster 102 is compatible with a version of the central manager 118. In some embodiments, the predeployment compatibility check 212 determines whether an operating system of the cluster 102 is in installed state. In some embodiments, the operating system of the cluster 102 is running in the workload 104 or the hypervisor 108.

The predeployment compatibility check 212 determines a health status of one or more components in the computer system 100. For example, the predeployment compatibility check 212 determines a health status of the MSP controller 122 and the IAM service 116. In some embodiments, the predeployment compatibility check 212 determines a health status by sending an API request or RPC request to an endpoint (e.g., port of a component). The endpoint may be used or dedicated for health queries. In some embodiments, if the predeployment compatibility check 212 receives a first response (e.g., a 200 response) from the endpoint within a first time interval, the predeployment compatibility check 212 determines that the component associated with the endpoint has a satisfactory health status (e.g., is healthy). In some embodiments, if the predeployment compatibility check 212 receives a second response, or no response at all, from the endpoint within a first time interval, the predeployment compatibility check 212 determines that the component associated with the endpoint has an unsatisfactory health status (e.g., is not healthy).

In some embodiments, a number of the services including the predeployment port check 210 and the predeployment compatibility check 212 are selectable plugins to the pre-check service 120 (e.g., pre-check framework). In some embodiments, a user or administrator running the pre-check service 120 can choose which of the number of services/plugins to run as part of the pre-check service 120.

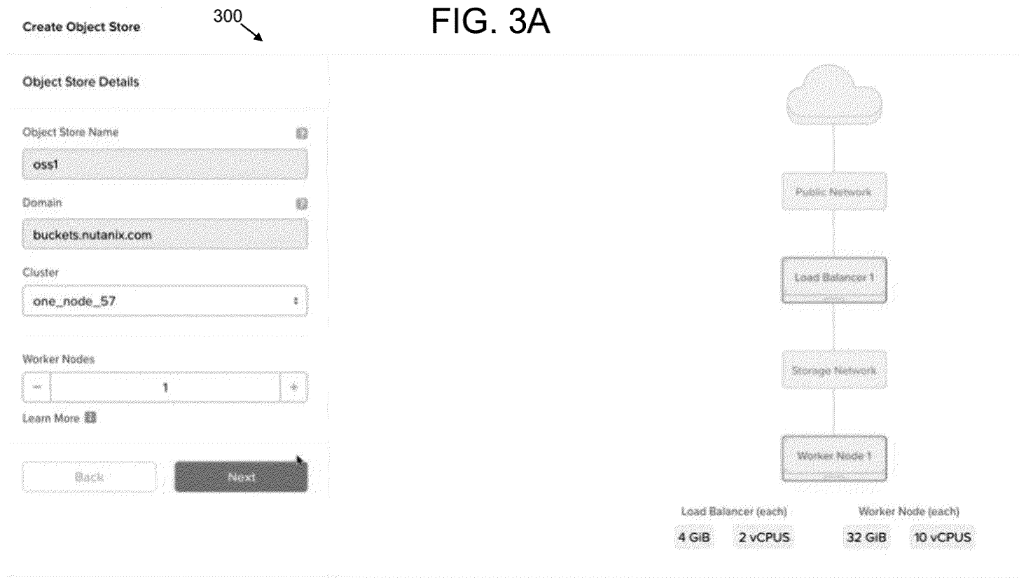

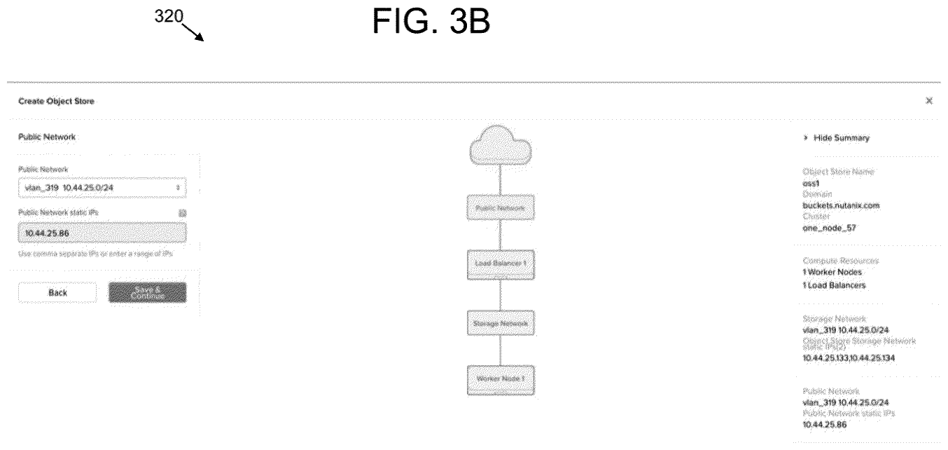

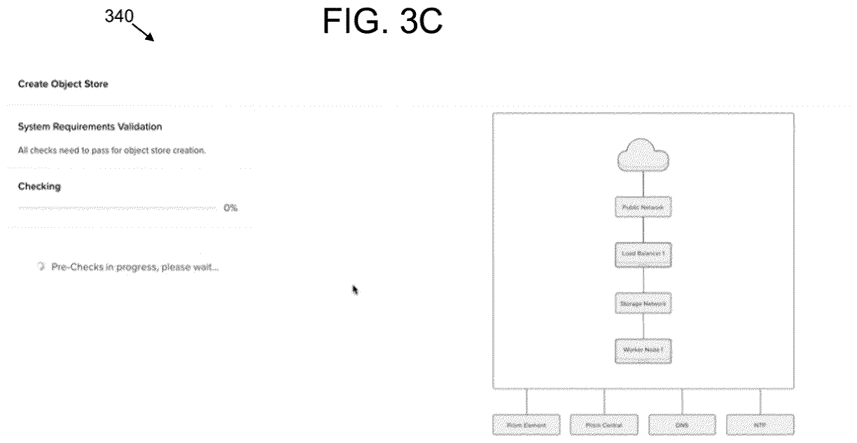

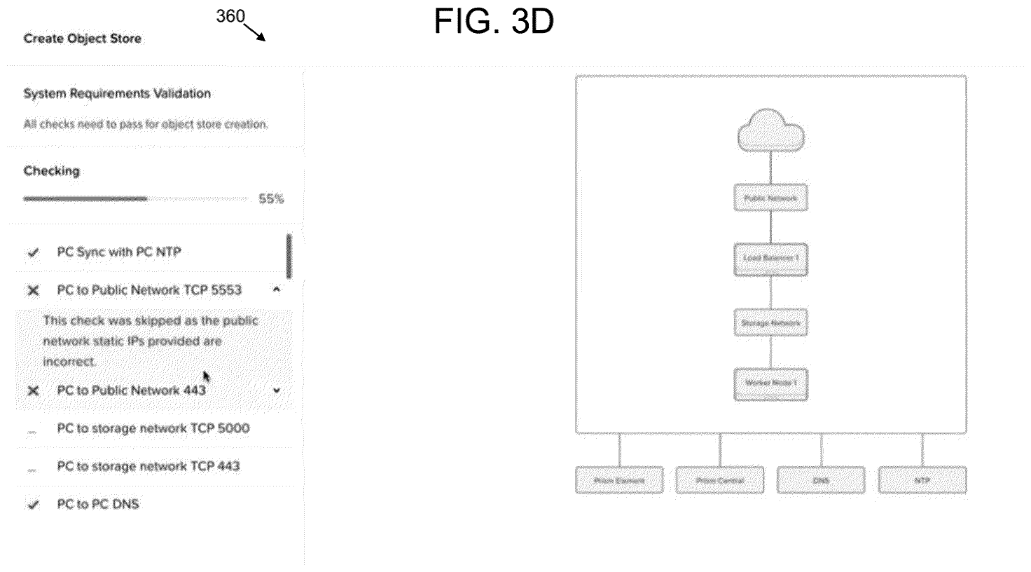

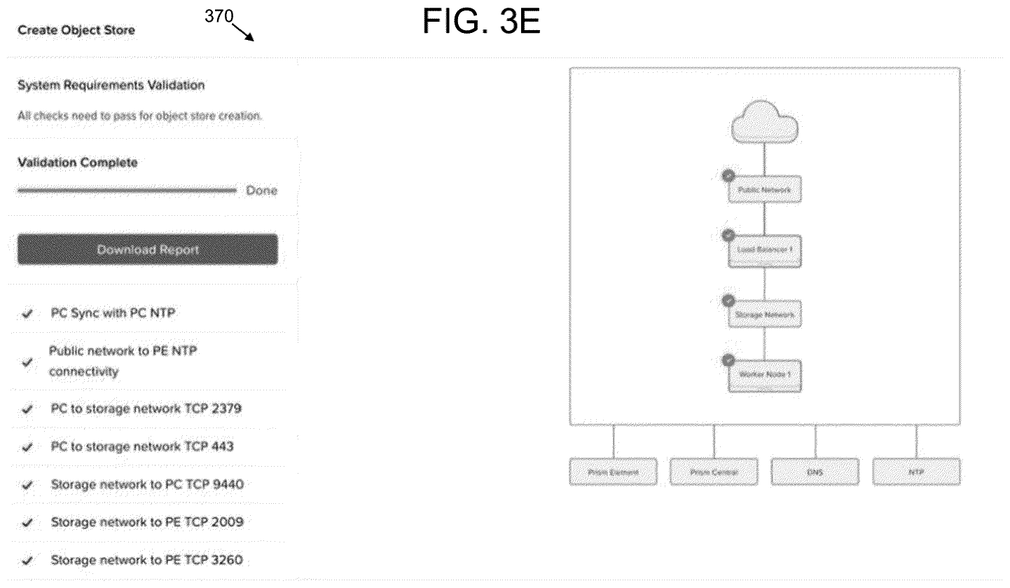

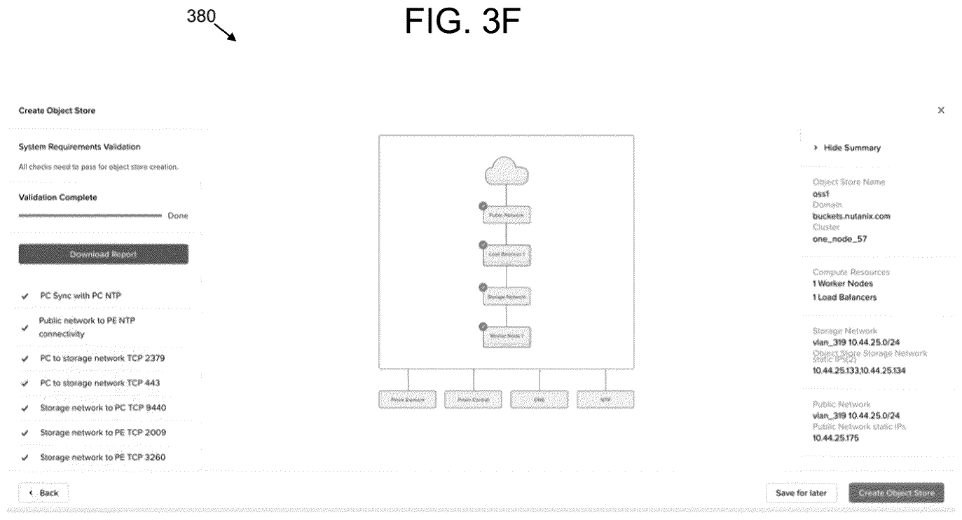

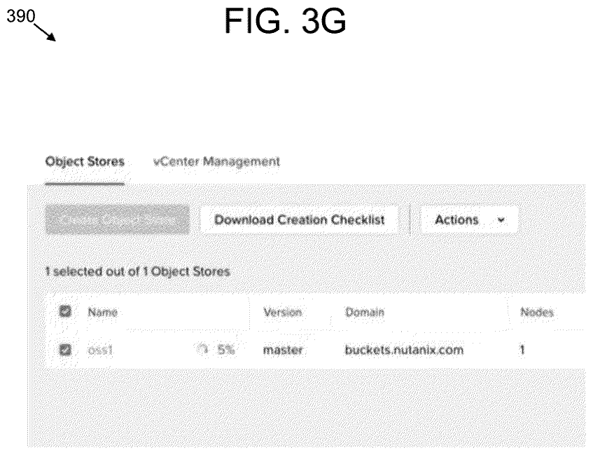

FIG. 3A illustrates a display 300, in accordance with some embodiments. The storage medium 204 includes the UI service 214. The UI service 214 provides an interface for a user or administrator to pre-check an object store deployment. In some embodiments, the UI service 214 provides the display 300 to configure an object store such as the object store 110. In some embodiments, the display 300 includes fields for inputting at least one of an object store name, an object store domain name, a cluster name, a number of worker nodes, a storage or memory amount corresponding to the number of worker nodes, a number of load balancer nodes, or a storage or memory amount corresponding to the number of load balancer nodes. In some embodiments, the UI service 214 receives a first user input. The first user input may be a selection/input for configuring the object store.

FIG. 3B illustrates a display 320, in accordance with some embodiments. In some embodiments, the UI service 214 provides the display 320 to configure an object store. In some embodiments, the UI service 214 provides the display 320 to execute a pre-check of the object store based on the first user input. In some embodiments, the UI service 214 receives a second user input. The second user input may be a selection/input for finalizing the configuration and for beginning execution of the pre-check. Display 320 may be provided after display 300. In some embodiments, the display 320 includes fields for inputting at least one of a public network name, a public network IP address, a storage network name, or a storage network IP address. In some embodiments, the display 320 displays information inputted in either display 300 or display 320.

FIG. 3C illustrates a display 340, in accordance with some embodiments. In some embodiments, the UI service 214 provides the display 340 to show progress of an execution of a pre-check of the object store based on the first user input. In some embodiments, the display 340 shows a percentage of the pre-check that is completed.

FIG. 3D illustrates a display 360, in accordance with some embodiments. In some embodiments, the UI service 214 provides the display 360 that indicates that the pre-check has failed based on the first and second user inputs. In some embodiments, the display 360 shows the results of the failed pre-check. In some embodiments, the UI service 214 receives a third user input. The third user input may be a selection to return to the display 300 to reconfigure the object store. In some embodiments, the UI receive may receive a number of inputs to modify firewall settings, fix errors, or to otherwise modify or fix the object store configuration in response to determining that the pre-check failed.

FIG. 3E illustrates a display 370, in accordance with some embodiments. In some embodiments, the UI service 214 provides the display 370 that indicates that the pre-check has passed based on the first and second user inputs. In some embodiments, the display 370 shows the results of the passed pre-check.

FIG. 3F illustrates a display 380, in accordance with some embodiments. In some embodiments, the UI service 214 provides the display 380 to deploy the object store. In some embodiments, the display 380 is based on indicating that the pre-check has passed. In some embodiments, the UI service 214 receives a fourth user input. The fourth user input may be a selection for deploying the object store.

FIG. 3G illustrates a display 390, in accordance with some embodiments. In some embodiments, the UI service 214 provides the display 390 to show progress of deploying the object store. In some embodiments, the display 390 shows a percentage of the object deployment that is completed.

Referring back to FIG. 2, in some embodiments, the pre-check service 120 includes a network interface 206. The network interface 206 allows the pre-check service 120 communicate with other components of the computer system 100. The network interface 206 includes wireless network interfaces such as BLUETOOTH, WIFI, Global System for Mobile Communications (GSM), wideband code division multiple access (WCDMA), Long-Term Evolution (LTE), or 5G; or wired network interfaces such as ETHERNET or Universal serial bus (USB).

In some embodiments, the pre-check service 120 includes a bus 208. The bus 208 is coupled to, and allows communication between, the processor 202, the computer-readable storage medium 204, and the network interface 206. In some embodiments, the bus 208 is a number of wires, optical fiber, a high-speed bus, etc.

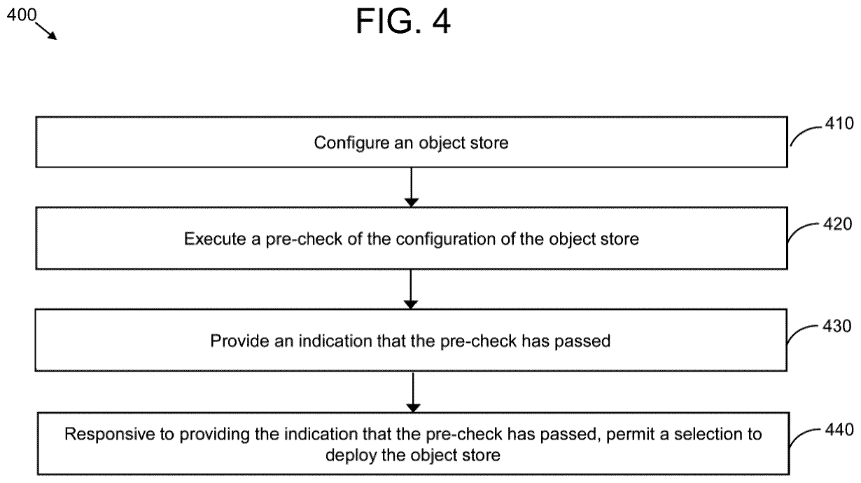

Referring now to FIG. 4, a flowchart of an example method 400 of performing a pre-check is illustrated, in accordance with some embodiments of the present disclosure. The method 400 may be implemented using, or performed by, the computer system 100, one or more components of the computer system 100, or a processor associated with computer system 100 or the one or more components of computer system 100. Additional, fewer, or different operations may be performed in the method 400 depending on the embodiment.

In brief overview, in some embodiments, a processor configure an object store (at operation 410), executes a pre-check of the configuration of the object store (at operation 420), provides an indication that the pre-check has passed (at operation 430), and, responsive to providing the indication that the pre-check has passed, permits a selection to deploy the object store (at operation 410).

In greater detail, at operation 410, in some embodiments, the processor configures an object store. In some embodiments, the processor selects a number of compute resources (e.g., the resource 106), a memory or storage amount associated with the number of compute resources, a storage network (e.g., the internal network 132), a public network (e.g., the external network 134), and an IP address for each of the storage network and public network. In some embodiments, the processor selects a number of workers (e.g., the worker 112) and a number of load balancers (e.g., the load balancer 114). In some embodiments, the processor selects an object store name, a domain name, and a cluster name.

At operation 420, in some embodiments, the processor executes a pre-check of the configuration of the object store. In some embodiments, the processor determines (e.g., checks, tests) whether there is connectivity between a number of ports (e.g., a port for the central manager 118, a port for the cluster 102, a port for the object store 110, a port for the DNS server 126, a port for the NTP server 128, a port for the client 130). In some embodiments, the ports are connected in an internal network (e.g., the internal network 132) or an external network (e.g., the external network 134).

In some embodiments, the processor executes, using a lightweight VM (e.g., the lightweight VM 124), a pre-check of the configuration of the object store. In some embodiments, the lightweight VM is a VM with an image from which the VM boots or loads, wherein the image has a size smaller than a predetermined size (e.g., 1 GB, 100 MB, or 10 MB). In some embodiments, the cache is a CBRC. In some embodiments, the cache stores the image and metadata about the image such as a block, offset, or other location information of the image.

At operation 430, in some embodiments, the processor, the processor provides an indication that the pre-check has passed. In some embodiments, the indication that the pre-check is provided through a UI or a command line interface (CLI). In some embodiments, the processor provides an indication that the pre-check has failed.

At operation 440, in some embodiments, responsive to providing the indication that the pre-check has passed, the processor permits a selection to deploy the object store. In some embodiments, the processor provides a selection to deploy the object store through a UI or CLI. In some embodiments, responsive to providing the indication that the pre-check has failed, the processor does not permit a selection (e.g., restricts a user from making the selection) to deploy the object store.

Each of the components (e.g., elements, entities) of the computer system 100 (e.g., the cluster 102, the object store 110, the worker 112, the load balancer 114, the IAM service 116, the central manager 118, the pre-check service 120, the MSP controller 122, the DNS server 126, and the NTP server 128), is implemented using hardware, software, or a combination of hardware or software, in one or more embodiments. Each of the components of the computer system 100 may be a processor with instructions or an apparatus/device (e.g., server) including a processor with instructions, in some embodiments. Each of the components of the computer system 100 can include any application, program, library, script, task, service, process, plugin, or any type and form of executable instructions executed by one or more processors, in one or more embodiments. Each of the one or more processors is hardware, in some embodiments. The instructions may be stored on one or more computer readable and/or executable storage media including non-transitory storage media.

It is understood that the embodiments described in herein with respect to a component (e.g., cluster 102, workload 104, resource 106, the object store 110, the lightweight VM 124) can apply to all of the components of that type (e.g., the number of clusters, the number of workloads, the number of resources, the number of object stores, the number of lightweight VMs, respectively). A first instance of the component can be one embodiment and a second instance of the component can be a different embodiment. For example, a first resource can be storage resource and a second resource can be a CPU resource.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A non-transitory computer readable storage medium having instructions stored thereon that, upon execution by a processor, causes the processor to:
configure a data store with a configuration;
execute, using a lightweight virtual machine (VM), a pre-check of the configuration of the data store;
provide an indication that the pre-check has passed; and
responsive to providing the indication that the pre-check has passed, permit a selection to deploy the data store.

2. The medium of claim 1, wherein the data store is an object store.

3. The medium of claim 1, wherein the pre-check includes a pre-deployment port check comprising a check of connectivity between a data store port and a second port.

4. The medium of claim 3, wherein the second port comprises a port of a cluster, wherein deploying the data store comprises deploying the data store to the cluster.

5. The medium of claim 3, wherein the second port comprises a port of a domain name system (DNS) server.

6. The medium of claim 3, wherein the pre-check includes a predeployment compatibility check comprising a check of compatibility between the data store and a workload configured to run the data store.

7. The medium of claim 1, wherein the pre-check includes a pre-deployment compatibility check comprising a check of compatibility between the data store and a workload configured to run the data store.

8. The medium of claim 7, wherein the check of compatibility between the data store and the workload comprises determining whether an operating system of the workload is in an installed state.

9. The medium of claim 7, wherein the check of compatibility between the data store and the workload comprises a check of compatibility between the data store and a cluster, wherein the cluster includes the workload.

10. The medium of claim 1, wherein the lightweight VM boots from an image smaller than one gigabyte.

11. The medium of claim 10, wherein the image is stored in a cache.

12. The medium of claim 1, wherein deploying the data store comprises deploying the data store to a cluster located in a hybrid cloud spanning one or more data centers and one or more clouds.

13. The medium of claim 1, wherein deploying the data store includes deploying one or more VMs configured to execute tasks associated with API requests received at the data store.

14. An apparatus comprising a processor and memory, wherein the memory includes instructions that, when executed by the processor, cause the apparatus to:
configure a data store;
execute, using a lightweight VM, a pre-check of the configuration of the data store;
provide an indication that the pre-check has passed; and
responsive to providing the indication that the pre-check has passed, permit a selection to deploy the data store.

15. The apparatus of claim 14, wherein the data store is an object store.

16. The apparatus of claim 14, wherein the pre-check includes a pre-deployment port check comprising a check of connectivity between a data store port and a second port.

17. The apparatus of claim 16, wherein the second port comprises a port of a cluster, wherein deploying the data store comprises deploying the data store to the cluster.

18. The apparatus of claim 16, wherein the second port comprises a port of a domain name system (DNS) server.

19. The apparatus of claim 16, wherein the pre-check includes a pre-deployment compatibility check comprising a check of compatibility between the data store and a workload configured to run the data store.

20. The apparatus of claim 14, wherein the pre-check includes a pre-deployment compatibility check comprising a check of compatibility between the data store and a workload configured to run the data store.

21. The apparatus of claim 20, wherein the check of compatibility between the data store and the workload comprises determining whether an operating system of the workload is in an installed state.

22. The apparatus of claim 20, wherein the check of compatibility between the data store and the workload comprises a check of compatibility between the data store and a cluster, wherein the cluster includes the workload.

23. The apparatus of claim 14, wherein the lightweight VM boots from an image smaller than one gigabyte.

24. The apparatus of claim 23, wherein the image is stored in a cache.

25. The apparatus of claim 14, wherein deploying the data store comprises deploying the data store to a cluster located in a hybrid cloud spanning one or more data centers and one or more clouds.

26. The apparatus of claim 14, wherein deploying the data store includes deploying one or more VMs configured to execute tasks associated with API requests received at the data store.
